(19) United States
(12) Patent Application Publication
(10) Pub. No.: US 2009/0282875 A1
(43) Pub. Date: Nov. 19, 2009

(54) Method and Apparatus Pertaining to Selectively Blocking a Lock Hasp

(76) Inventors: Robert John Olmsted, Wood Dale, IL (US); James J. Fitzgibbon, Batavia, IL (US); Justen S. Ferguson, Peoria, AZ (US)

Correspondence Address: FITCH EVEN TABIN & FLANNERY, 120 SOUTH LASALLE STREET, SUITE 1600, CHICAGO, IL, 60603-3406, US

(21) Appl. No.: 12/123,159

(22) Filed: May 19, 2008

(51) Int. Cl. E05B 65/48

(52) U.S. Cl. 70/2

(57) ABSTRACT

These various embodiments can be deployed in conjunction with a movable barrier (100) and an end user manipulable lock hasp (300) and generally provide a movable hasp-blocking member (301) and a transport member (302) that can selectively move that hasp-blocking member between a hasp-blocking position and a non-blocking position. By one approach, this transport member further comprises a locking component (305) that readily permits the movable hasp-blocking member to be pulled from the hasp-blocking position towards the non-blocking position but that resists pushing of the movable hasp-blocking member towards the non-blocking position. These teachings will also generally provide for a barrier mounting member that is configurable to secure the movable hasp-blocking member and the remotely controllable transport member to the movable barrier.

### TECHNICAL FIELD

This invention relates generally to lock hasps and more particularly to lock hasp overlooking.

### BACKGROUND

Lock hasps of various kinds are known in the art. In this context, a hasp comprises a locking member that can be secured in a locked position by, for example, a padlock, pin, or the like. End user manipulable lock hasps are used, for example, in conjunction with self storage facilities in order to permit a subscribing end user to use their own personal locking device, such as a padlock, to lock the movable barrier that provides access to their assigned storage areas.

Overlocking is also known in the art. Overlocking generally comprises the practice of accommodating an additional lock, such as an additional padlock, when securing a lock hasp in place. Self storage facilities often make use of overlooking in order to prevent a subscriber from gaining access to their assigned storage area when they are in arrears with respect to the terms and conditions of their rental agreement and/or to secure an unassigned storage area from being accessed by unauthorized individuals.

Numerous practical problems are associated with overlooking approaches that make use of a supplemental padlock. Such an approach, for example, can increase manpower requirements for a given self storage facility in order to timely apply and remove overlooking padlocks from individual storage units. As a given facility can have hundreds or even thousands of individual storage units, such servicing can present a considerable logistics challenge.

### BRIEF DESCRIPTION OF THE DRAWINGS

The above concerns are at least partially met through provision of the method and apparatus pertaining to selectively blocking a lock hasp described in the following detailed description, particularly when studied in conjunction with the drawings, wherein:

FIG. 1 comprises a perspective detail view as configured in accordance with the prior art;

FIG. 2 comprises a front elevational view as configured in accordance with the prior art;

FIG. 3 comprises a front elevational view as configured in accordance with various embodiments of the invention;

FIG. 4 comprises a detail perspective view as configured in accordance with various embodiments of the invention;

FIG. 5 comprises a detail front elevational view as configured in accordance with various embodiments of the invention; and

FIG. 6 comprises a front elevational view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments can be deployed in conjunction with a movable barrier and an end user manipulable lock hasp. These embodiments generally provide a movable hasp-blocking member and a transport member that is configured to selectively move that movable hasp-blocking member between a hasp-blocking position (that prevents the hasp from being moved by an end user to an unsecured position that will permit the end user to move the movable barrier to an opened position) and a non-blocking position (that does not prevent the hasp from being moved by the end user to the unsecured position). By one approach, this transport member further comprises a locking component that readily permits the movable hasp-blocking member to be pulled from the hasp-blocking position towards the non-blocking position but that resists pushing of the movable hasp-blocking member towards the non-blocking position. These teachings will also generally provide for a barrier mounting member that is configurable to secure the movable hasp-blocking member and the remotely controllable transport member to the movable barrier.

By one approach, the aforementioned locking component comprises an articulated portion that bears at least one pin, such that when the movable hasp-blocking member is in the hasp-blocking position, the at least one pin resists forced movement of the movable hasp-blocking member towards the non-blocking position.

So configured, those skilled in the art will appreciate that such a movable hasp-blocking member can be selectively manipulated to be placed in proximity to an exterior periphery of the hasp to thereby prevent the hasp from being moved by an end user to an unsecured position and to similarly permit selectively moving the movable hasp-blocking member to a non-proximal location that does not interfere with the exterior periphery of the hasp and hence does not prevent such end user manipulations of the hasp.

These teachings can be readily deployed with respect to new installations but can also be readily used in conjunction with already-installed end user manipulable lock hasps. By one approach the movement of the transport member can be made subject to the receipt of a remote control signal to thereby permit, for example, the manager of a self storage facility to engage or disengage the movable hasp-blocking member with respect to the lock hasp as desired without requiring that manager or another authorized person to personally and physically visit the corresponding self storage unit. These teachings are readily realized using existing technologies and will no doubt also readily accommodate future developments in these regards.

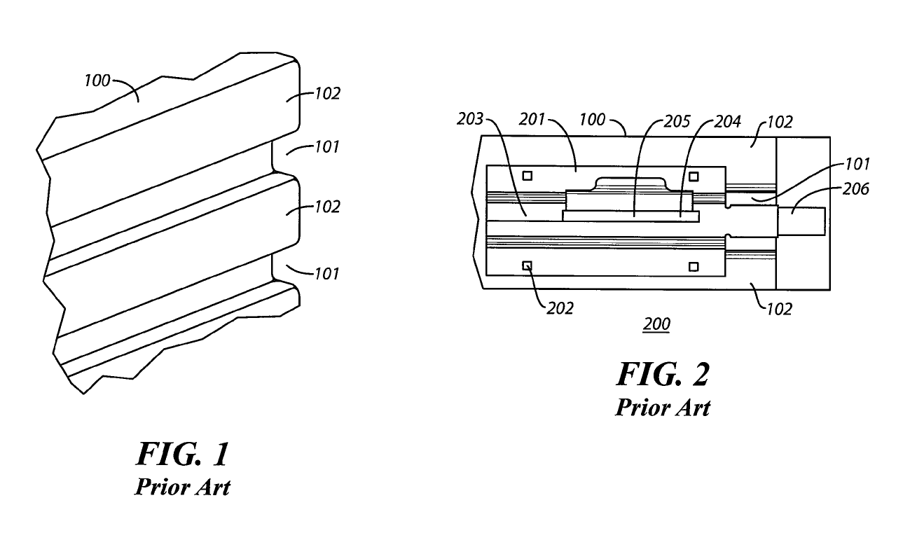

These and other benefits may become clearer upon making a thorough review and study of the following detailed description. Referring now to the drawings, and in particular to FIG. 1, it may be helpful to first provide a more detailed description of certain relevant prior art elements. Many prior art movable barriers 100 comprise a somewhat flexible rolling shutter that features horizontally-disposed corrugation-like elements. These elements include regularly spaced recessed areas 101 that vertically separate other raised portions 102 of the movable barrier 100. This configuration, in turn, permits some degree of flexure that permits the movable barrier to be moved along a track that includes an arcuate portion (to thereby permit, for example, a majority of the movable barrier 100 to be disposed horizontally when in an opened position and parallel to a ceiling of the corresponding storage unit).

These recessed areas 101 are sometimes used to receive a corresponding end user manipulable lock hasp assembly 200 as illustrated in FIG. 2. Such an assembly 200 typically features a frame 201 having flanges 201 that meet the raised portions 102 of the movable barrier 100 and a housing portion 203 that fits within the recessed area 101 of the movable barrier 100. The flanges 201, in turn, often have holes 202 formed therethrough to permit the lock hasp assembly 200 to be securely attached to the movable barrier 100 by use of rivets, tamper-proof bolts, or the like.

This lock hasp assembly 200 also features an end user manipulable lock hasp 204 that can slide back and forth, horizontally, in order to move a hand-manipulable portion 205 at one end and a locking portion 206 at the opposing end. The locking portion 206 can comprise, for example, a blade that fits within a corresponding recess in the movable barrier frame (not shown) and which serves, when so placed, to prevent the movable barrier 100 from being moved vertically. The hand-manipulable portion 205 often includes one or more holes formed therethrough to receive the end user's padlock to thereby permit the end user to lock the locking portion 206 in a locked position.

For the sake of illustration and example, the above-described prior art elements will be used when describing various aspects of various embodiments that accord with these teachings. Those skilled in the art will appreciate and recognize that the use of such examples is intended to serve only as an illustrative example and is not intended to serve as an exhaustive or otherwise limiting example in this regard. In particular, it will be clearly understood that these teachings are readily employed with movable barriers and lock hasp assemblies having differing form factors.

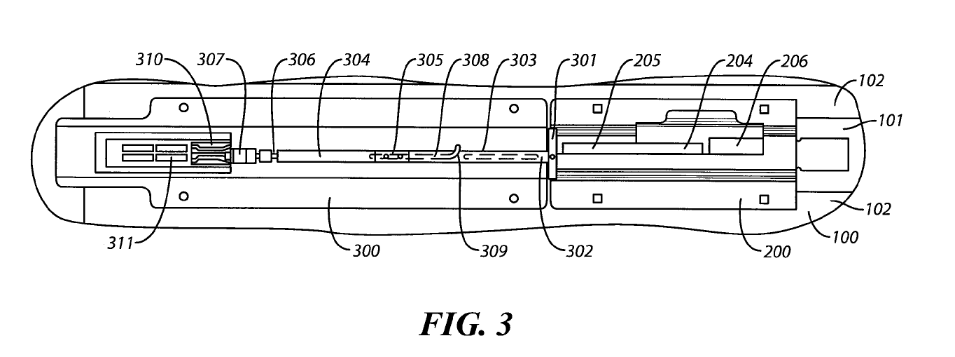

Referring now to FIG. 3, and to continue with the illustrative example begun above, by one approach the present apparatus 300 can be similarly fit within the recessed area 101 of a movable barrier 100 proximal to a similarly mounted lock hasp assembly 200. This apparatus 300 generally comprises a movable hasp-blocking member 301 that is operably coupled to a transport member 302. This transport member 302 is comprised of two coaxially-aligned longitudinal members comprising cylinders 303 and 304 with the first cylinder 303 being connected to the movable hasp-blocking member 301. These two cylinders 303 and 304 are, in turn, connected to one another by an articulated portion 305 that serves as a locking component as described herein.

The remaining cylinder 304 has an axially-disposed threaded bore that receives and interacts with a threaded drive shaft 306. This threaded drive shaft 306, in turn, is connected to the output of a motor 307. So configured, rotating the motor's output in one direction will cause the corresponding cylinder 304 to move away from the motor 307 and towards the lock hasp assembly 200 while rotating the motor's output in the opposite direction will cause the corresponding cylinder 304 to move away from the hasp lock assembly 200 and towards the motor 307.

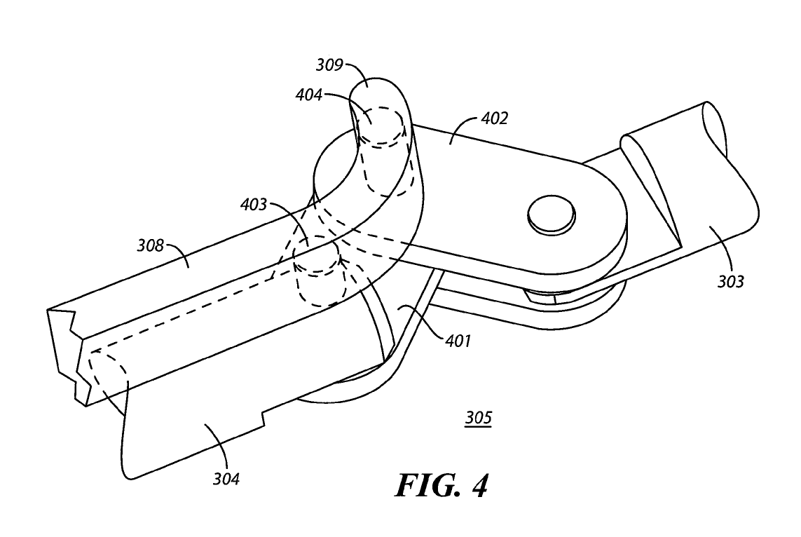

A cover (shown and described further herein) for the apparatus 300 has a track 308 formed therein. This track 308 is, for the most part, parallel to the transport member 302 but also includes at one end a curved portion 309. This track 308 is sized and configured to interact with one or more pins as comprise a part of the transport member 302. These pins and the aforementioned articulated portion 305 will now be described in more detail with reference to FIG. 4.

In this illustrative example, this articulated portion 305 comprises a first link 401 that is pivotally connected to the cylinder 304 of the transport member 302 that couples to the motor. This articulated portion 305 then further comprises a second link 402 that is pivotally connected to the remaining cylinder 303 of the transport member 302 (that is, the cylinder that connects to the aforementioned hasp-blocking member 301). This first link 401 and this second link 402 are then pivotally connected to one another to form the articulated portion 305.

As shown in FIG. 4, the motor-side cylinder 304 of the transport member 302 has a first pin 403 attached thereto that, in this illustrative example, extends outwardly in a perpendicular manner. The pivot point of the articulated portion 305 has a second pin 404 extending outwardly therefrom in a same direction as the first pin 403. Both of these pins 401 and 402 are disposed within the aforementioned track 308 which comprises a part of a cover for the overall assembly 300.

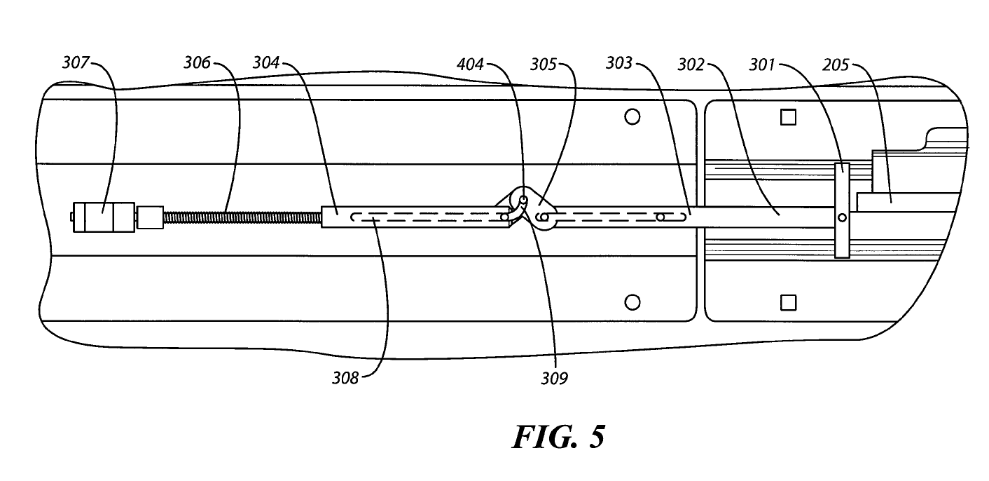

Referring to each of FIGS. 3, 4, and 5, those skilled in the art will now recognize and understand that as the transport member 302 is moved away from the motor 307 and towards the rearward portion 205 of the lock hasp 204, the second pin 404 which comprises a part of the articulated portion 305 will follow the arcuate portion 309 of the track to the conclusion of the track. At this point, the pin 404 will encounter the terminus of the track and halt further movement of the transport member 302 in this direction. At this point, as perhaps is most clearly shown in FIG. 5, the hasp-blocking member 301 will be in close proximity to the exterior periphery of the hasp 204 (for example, within 0.0 to 10.0 millimeters). So disposed, the hasp-blocking member 301 will now prevent the hasp 204 from being moved by an end user to an unsecured position that would permit the end user to then move the movable barrier 100 to an opened position.

More particularly, those skilled in the art will recognize and understand that the second pin 404 will interact with the curved portion 309 of the track to resist forced movement of the movable hasp-blocking member 301 back towards the non-blocking position shown in FIG. 3. (As used herein, it will be understood that this expression “resist” refers to a significant multiple of the amount of force that is required to move the hasp-blocking member 301 into this position in the first instance. For example, by this configuration, it may require ten times the force to push the articulated portion 309 back towards the motor 307 as was required to move the articulated portion 309 into this position. As another example, these parts could be comprised of materials and tolerances that would require exerting 100 times the initial placement effort. Generally speaking, for most purposes, it will suffice when the amount of resistance is greater than that which an average-sized adult person having average strength is able to impose by hand upon the end user manipulable lock hasp 204.)

Viewed another way, it will be readily appreciated that these teachings provide a locking component that readily permits the movable hasp-blocking member 301 to be pulled from the hasp-locking position (as shown in FIG. 5) towards the non-blocking position (as shown in FIG. 3) but that resists pushing of the movable hasp-blocking member towards the non-blocking position.

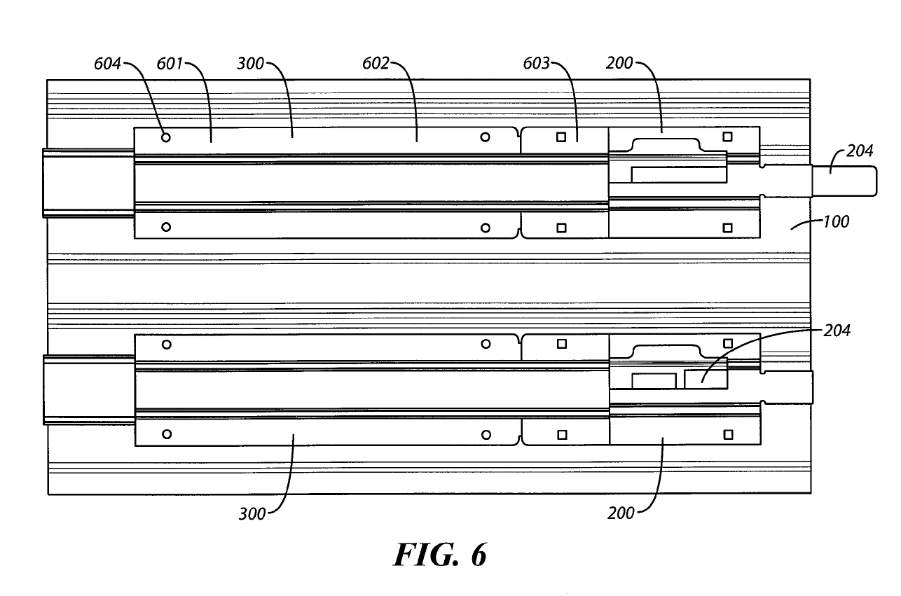

Referring now momentarily to FIG. 6, for the sake of illustration a single movable barrier 100 is shown with two such apparatuses 300 attached thereto in conjunction with two corresponding lock hasp assemblies 200 (one with its hasp in a barrier-locking position and the other with its hasp in a barrier-unlocked position). Each apparatus 300 has a frame portion 601 that is configured to fit within the recessed area of the movable barrier 100 in a manner akin to that described earlier for the lock hasp assembly 200. This frame portion 601 can have holes 604 disposed therethrough to permit the frame portion 601 to serve as a barrier mounting member that will permit the securing of the apparatus 300 and its components to the movable barrier 100 by use of rivets or the like.

In addition, the assembly 300 has a cover 602 that overlies the above-described elements to protect such elements from unauthorized access and to also provide the aforementioned track. By one approach, this cover 602 can have a portion 603 that also overlies a portion of the lock hasp assembly 200. This can provide further assurance against an unauthorized person unduly interfering with or otherwise frustrating the operation of the apparatus 300 as described.

Referring again to FIG. 3, the aforementioned motor 307 can connect to, and be controlled by, a controller circuit 310. These various components can receive their operating power from batteries 311 if desired to further support the self-sufficiency of the apparatus 300. By one approach, if desired, the controller circuit 310 can further comprise, or can otherwise operably couple to, a wireless receiver that is configured to receive wireless remote control signals. By this approach, the controller circuit 310 can respond to remote control signals that are sourced, for example, from the management office of a self storage facility to control the position and movement of the aforementioned transport member 304 (and hence the movable hasp-blocking member 301).

Those skilled in the art will recognize and appreciate that the aforementioned controller circuit 310 can comprise a fixed-purpose hard-wired platform or can comprise a partially or wholly programmable platform. All of these architectural options are well known and understood in the art and require no further description here. The processing of received remote control instructions and the corresponding operation of the motor 307 to move the hasp-blocking member 301 to blocking and non-blocking positions can be effected via, for example, corresponding programming as will be well understood by those skilled in the art.

Such an apparatus 300 can be readily used with a movable barrier having a corresponding end user manipulable lock hasp that is secured to that movable barrier. It will be appreciated and understood that such an apparatus 300 can be readily secured to the movable barrier and then used to selectively overlock the hasp by using the described transport member to move the movable hasp-blocking member to the hasp-blocking position. It will be further appreciated that such functionality can be achieved, if desired, in response to receiving a wireless remote control message. It will also be appreciated and understood that such an action can be readily reversed by again using the transport member to move the movable hasp-blocking member to the non-blocking position.

These teachings provide a highly cost effective, easily installed, readily maintained, and easily operated overlooking system that can be readily scaled to accommodate essentially any number of lock hasps in, for example, a self service storage facility. It will also be noted that these teachings are readily leveraged through use with any of a wide variety of lock hasp form factors and designs.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, and as suggested by FIGS. 3, 4, and 5, the apparatus 300 can comprise a second track that interacts with one or more pins that are borne by the cylinder 303 of the transport member 302 that interacts directly with the hasp-blocking member 301. These pins and this second track can cooperate with one another, for example, to provide a stop to properly terminate movement of the hasp-blocking member 301 when moving towards the hasp.

We claim:

1. An apparatus for use with a movable barrier and an end user manipulable lock hasp, comprising:
a movable hasp-blocking member;
a transport member configured to selectively move the movable hasp-blocking member between:
a hasp-blocking position that prevents the hasp from being moved by an end user to an unsecured position that will permit the end user to move the movable barrier to an opened position; and
a non-blocking position that does not prevent the hasp from being moved by the end user to the unsecured position;
wherein the transport member further comprises an articulated portion that bears at least one pin, such that when the movable hasp-blocking member is in the hasp-blocking position, the at least one pin resists forced movement of the movable hasp-blocking member towards the non-blocking position;
a barrier mounting member configurable to secure the movable hasp-blocking member and the remotely controllable transport member to the movable barrier.

2. The apparatus of claim 1 wherein the end user manipulable lock hasp is attached to the movable barrier.

3. The apparatus of claim 1 wherein the transport member comprises a first longitudinal member and a second longitudinal member that are operably coupled by the articulated portion.

4. The apparatus of claim 3 wherein the first longitudinal member and the second longitudinal member are disposed substantially co-axial to one another.

5. The apparatus of claim 4 wherein the articulated portion comprises a first link that is pivotally connected to the first longitudinal member and a second link that is pivotally connected to the second longitudinal member.

6. The apparatus of claim 1 further comprising a track that receives the at least one pin.

7. The apparatus of claim 6 wherein the track comprises a curved portion that guides the at least one pin into a particular position, when the movable hasp-blocking member is in the hasp blocking position, that causes the pin to resist the forced movement of the movable hasp-blocking member towards the non-blocking position.

8. The apparatus of claim 1 further comprising:
a transport member mover configured to selectively move the transport member between the hasp-blocking position and the non-blocking position.

9. The apparatus of claim 8 further comprising:
a wireless receiver that is configured to receive wireless remote control signals and wherein the transport member mover is responsive to the remote control signals.

10. An apparatus for use with a movable barrier and an end user manipulable lock hasp, comprising:
a movable hasp-blocking member;
a transport member configured to selectively move the movable hasp-blocking member between:
a hasp-blocking position that prevents the hasp from being moved by an end user to an unsecured position that will permit the end user to move the movable barrier to an opened position; and
a non-blocking position that does not prevent the hasp from being moved by the end user to the unsecured position;
wherein the transport member further comprises a locking component that readily permits the movable hasp-blocking member to be pulled from the hasp-blocking position towards the non-blocking position but that resists pushing of the movable hasp-blocking member towards the non-blocking position;
a barrier mounting member configurable to secure the movable hasp-blocking member and the remotely controllable transport member to the movable barrier.

11. The apparatus of claim 10 wherein the locking component comprises an articulated portion that bears at least one pin, such that when the movable hasp-blocking member is in the hasp-blocking position, the at least one pin resists forced movement of the movable hasp-blocking member towards the non-blocking position.

12. The apparatus of claim 11 wherein the articulated portion comprises a first link that is pivotally connected to the first longitudinal member and a second link that is pivotally connected to the second longitudinal member.

13. The apparatus of claim 12 further comprising a track that receives the at least one pin.

14. The apparatus of claim 13 wherein the track comprises a curved portion that guides the at least one pin into a particular position, when the movable hasp-blocking member is in the hasp blocking position, that causes the pin to resist the forced movement of the movable hasp-blocking member towards the non-blocking position.

15. An apparatus for use with a movable barrier and an end user manipulable lock hasp, wherein the hasp has an exterior periphery, the apparatus comprising:
a movable hasp-blocking member;
a transport member configured to selectively move the movable hasp-blocking member between:
a hasp-blocking position that positions the hasp-blocking member to be in proximity of the exterior periphery of the hasp and thereby prevent the hasp from being moved by an end user to an unsecured position that will permit the end user to move the movable barrier to an opened position and a non-blocking position; and
a non-blocking position that does not prevent the hasp from being moved by the end user to the unsecured position;
a barrier mounting member configurable to secure the movable hasp-blocking member and the remotely controllable transport member to the movable barrier.

16. The apparatus of claim 15 wherein the transport member further comprises a locking component that readily permits the movable hasp-blocking member to be pulled from the hasp-blocking position towards the non-blocking position but that resists pushing of the movable hasp-blocking member towards the non-blocking position.

17. The apparatus of claim 16 wherein the locking component comprises an articulated portion that bears at least one pin, such that when the movable hasp-blocking member is in the hasp-blocking position, the at least one pin resists forced movement of the movable hasp-blocking member towards the non-blocking position.

18. A method for use with a movable barrier and an end user manipulable lock hasp that is secured to the movable barrier, wherein the hasp has an exterior periphery, the method comprising:
securing to the movable barrier an apparatus comprising:
a movable hasp-blocking member;
a transport member configured to selectively move the movable hasp-blocking member between:
a hasp-blocking position that positions the hasp-blocking member to be in proximity the exterior periphery of the hasp and thereby prevent the hasp from being moved by an end user to an unsecured position that will permit the end user to move the movable barrier to an opened position; and
a non-blocking position that does not prevent the hasp from being moved by the end user to the unsecured position;
a barrier mounting member configurable to secure the movable hasp-blocking member and the remotely controllable transport member to the movable barrier.

19. The method of claim 18 further comprising:
using the apparatus to selectively overlock the hasp by using the transport member to move the movable hasp-blocking member to the hasp-blocking position.

20. The method of claim 19 wherein using the apparatus to selectively overlock the hasp comprises receiving a wireless remote control message.

21. The method of claim 20 further comprising:
using the apparatus to selectively undo the overlock by using the transport member to move the movable hasp-blocking member to the non-blocking position.
